(19) United States
(12) Patent Application Publication
(10) Pub. No.: US 2010/0021336 A1
(43) Pub. Date: Jan. 28, 2010

(54) BALL PIN AND BUSHINGS COMPOSED OF RUST-RESISTANT STEEL

(75) Inventor: Jochen Kruse, Osnabruck (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/518,507

(22) PCT Filed: Dec. 17, 2007
(86) PCT No.: PCT/DE07/02289

§ 371 Date: Jun. 10, 2009

(30) Foreign Application Priority Data
Dec. 20, 2006 (DE) 10 2006 060 994.8

(51) Int. Cl. F16C 11/06; C22C 38/18; B22D 11/00; C22C 38/20; C22C 38/30; C22C 38/28; C22C 38/22; C22C 38/32; C22C 38/24; C22C 38/26

(52) U.S. Cl. 420/36; 420/34; 164/476; 420/60; 420/70; 420/67; 420/64

(57) ABSTRACT

A ball pin or ball socket made of stainless steel with the following composition: 10.5 to 13 wt.-% of chromium, 0.005 to 0.3 wt.-% of carbon, maximum 0.015 wt.-% of sulfur, 0.2 to 1 wt.-% of silicon, 0.2 to 1 wt.-% of manganese with a balance of the composition being iron.

This application is a National Stage completion of PCT/DE2007/002289 filed Dec. 17, 2007, which claims priority from German patent application serial no. 10 2006 060 994.8 filed Dec. 20, 2006.

### FIELD OF THE INVENTION

The invention concerns ball pins and ball sockets, and methods for their production.

### BRIEF DESCRIPTION OF THE DRAWINGS

Ball pins and ball sockets are used for example in steering rods, tie-rods and thrust bars, transverse control arms and track-rods of motor vehicles. For such applications the balls and ball sockets must have exceptionally accurate dimensions and, moreover, excellent surface quality.

Fundamental information about ball pins and ball sockets can be obtained for example from DE 10 2005 019 559 A1 and DE 100 23 602 C2.

Ball pins of the prior art for passenger motor vehicles are made as a rule from the heat-treatable steels 41Cr4 or 42CrMo4. The steel is melted and continuously cast into bars. The bars are then hot-rolled down to wire rods in the diameter range 10 mm to 30 mm. To be able to produce the ball pins from these wire rods in a multi-stage press, the wire rod must be annealed to produce a spheroidal cementite structure (annealed to spheroidal cementite=ASC). For this, the wire rod is heated, coated in a phosphate bath, drawn, recrystallized by annealing, reheated and phosphated. The wire rod is then drawn to its final diameter, to close tolerance. In a multi-stage press, the pressed blank for the ball pin is made from the drawn wire rod. To produce the desired strength, the pressed ball pin blanks have to be heat treated. The pressed blanks are heated to around 900° C. (austenitized), rapidly quenched in water or oil (hardened) and heated again to temperatures of 500° C. to 600° C. (tempered). The ball pins are then machined or shaped without cutting. The procedure is analogous for producing ball sockets. Of course, ball pins and ball sockets can also be produced in other ways.

When ball pins and ball sockets have to be protected against corrosion, after their production and perhaps subsequent grinding they are cyanided. During this, carbon and nitrogen diffuse into the surface layer. This makes the outer zone of the steel hard, wear-resistant and corrosion-resistant. In the neutral salt-spray test according to DIN 50021 (DIN=Deutsche Industrienorm=German Industrial Standard) the corrosion resistance amounts as a rule to 96 hours for threaded areas and as a rule to 480 hours for other areas. The cyanide treatment is carried out after the production of the ball pins and ball sockets in a distinct, often spatially separate step. Particularly during transport, special care must be taken that the surface of the ball pins is not damaged, since otherwise the corrosion protection achieved is less good and the dimensional accuracy suffers. Since the nitriding is carried out in batches, the individual batches of ball pins and ball sockets have to be tested in a time-consuming way for corrosion resistance after being coated.

### SUMMARY OF THE INVENTION

The purpose of the present invention was to overcome the disadvantages of the prior art, in particular to eliminate the time-consuming step of cyaniding/coating while maintaining or even extending the corrosion resistance time.

It has been found that the cyaniding treatment can be omitted, if the ball pins or ball sockets are made from a stainless steel with the following composition: iron, with 10.5 to 13 wt.-% of chromium, 0.005 to 0.3 wt.-% of carbon, maximum 0.015 wt.-% of sulfur, 0.2 to 1 wt.-% of silicon, 0.2 to 1.0 wt.-% of manganese (The abbreviation wt.-% means percent by weight).

Despite the omission of a separate coating step the ball pins and ball sockets according to the invention have corrosion resistance times at least as long as the nitrided ball pins or ball sockets of the prior art, but without needing a separate coating process, in particular cyaniding, to achieve this. Preferably, the corrosion resistance times are substantially longer.

According to the invention, therefore, a stainless steel is used, i.e. a steel containing at least 50% of iron and in which the chromium content is between 10.5 and 13 wt.-%. Basically, very corrosion-resistant steels are also known which have much higher chromium contents. However, these are expensive and so not suitable for a mass-produced product.

The material according to the invention also has a carbon fraction in the range 0.005 to 0.3 wt.-%. Preferably, the carbon content is at most 0.1 wt.-%, and still more preferably at most 0.02 wt.-%. A lower carbon content improves the deformability of the steel.

For cost reasons the chromium content is as low as possible. Preferably, the chromium content is chosen as a function of the carbon content. A preferred chromium content range is calculated as follows:

Chromium content in wt.-%=11.5 wt.-%+10×(carbon content in wt.-%) to 12 wt.-%+20×(carbon content in wt.-%).

The maximum sulfur content is 0.015 wt.-%, a maximum content of 0.007 wt.-% being preferred.

In addition, the material contains 0.2 to 1 wt.-% and preferably 0.6 to 0.8 wt.-% of silicon, and 0.2 to 1 wt.-% and preferably 0.3 to 0.5 wt.-% of manganese.

Of course, stainless steel can contain other alloying elements as well, in larger or smaller amounts. In fact, depending on the production method other alloying constituents are usual.

Preferably, the ball pins or ball sockets contain a maximum of 0.06 wt.-% of aluminum.

In another embodiment the ball pins or ball sockets contain a maximum of 1 wt.-%, preferably at most 0.5 wt.-% of nickel.

One or more of the following elements may also be present:
maximum 0.05 wt.-% of phosphorus,
maximum 0.5 wt.-% of copper,
maximum 0.5 wt.-% of cobalt,
maximum 0.2 wt.-% of titanium,
maximum 0.5 wt.-% of molybdenum,
maximum 0.01 wt.-% of niobium,
maximum 0.01 wt.-% of boron,
maximum 0.2 wt.-% of vanadium,
maximum 0.1 wt.-% of nitrogen

The ball pins or ball sockets preferably have a ferritic-martensitic metallurgical structure. This is produced when, after casting, the steel is reheated so that more austenite is formed. During cooling after the steel has been hot-rolled to wire rods, this produces a distorted tetragonal lattice; the more rapid the cooling, the more martensite is produced. Preferably, the proportion of martensite structure is 5 to 25 wt.-%.

It has been demonstrated that in a neutral salt-spray test according to DIN 50021 the ball pins or ball sockets show no red rust after 720 hours. Other typical properties of the material used according to the invention are:
its high strength of Rm>850 MPa after a sizing drawing operation of 5 to 50%,
very high toughness (measured as notched-bar impact toughness on an ISO-V-test piece).

Surprisingly, it has been found that although the material has no appreciable sulfur content, it can be machined as well as the material used previously. The life of the machining tools is, if anything, somewhat longer than with the previously used materials. The steel according to the invention investigated in the examples has a sulfur content of only 0.002 wt.-%. The material used previously (41Cr4+QT tempered to 900 MPa), in contrast, has sulfur contents of 0.02 to 0.04 wt.-%. Both steels have approximately the same strength.

Furthermore, an object of the invention is a method for producing ball pins or ball sockets from a stainless steel having the composition specified in the claims. Surprisingly for those with knowledge of the field, it has been found that even without an elaborate ASC treatment, ball pins and ball sockets can be produced from wire rods in a multi-stage press. The expensive and elaborate ASC treatment can be omitted. Moreover, for those with knowledge of the field it was surprising that after pressing, the components have the same high strength otherwise obtained only in tempered components. Thus, using the steel according to the invention enables the more expensive and elaborate tempering process to be omitted. The production method includes at least the following steps:
melting the steel,
casting the steel into ingots or continuously,
hot rolling,
cold drawing,
machining.

Preferably, the blanks for the ball pins or ball sockets are produced by a multi-stage cold-forming process in which the blanks are pressed from the wire rod. Preferably, after the hot rolling stage, cold drawing by >5% is carried out to produce the required strength.

Furthermore, the wire rod is cooled after hot rolling at a rate >1 K/s (Kelvin per second). From this, the notched-bar impact work value obtained with ISO-V test pieces at 0° C.>200 J (Joules).

An additional object of the invention is the use of a stainless steel having the following composition:
iron, with
10.5 to 13 wt.-% of chromium,
0.005 to 0.3 wt.-% of carbon,
maximum 0.015 wt.-% of sulfur,
0.2 to 1 wt.-% of silicon,
0.2 to 1.0 wt.-% of manganese
   for the production of ball pins or ball sockets.

Such ball pins and ball sockets are particularly suitable for use in automotive engineering applications.

In automotive engineering they are used for example for steering rods, tie-rods and thrust bars, coupling rods or stabilizer connections, two-point and three-point transverse control members and track-rods.

### BRIEF DESCRIPTION OF THE DRAWINGS

The invention will now be described, by way of example, with reference to the accompanying drawings in which:

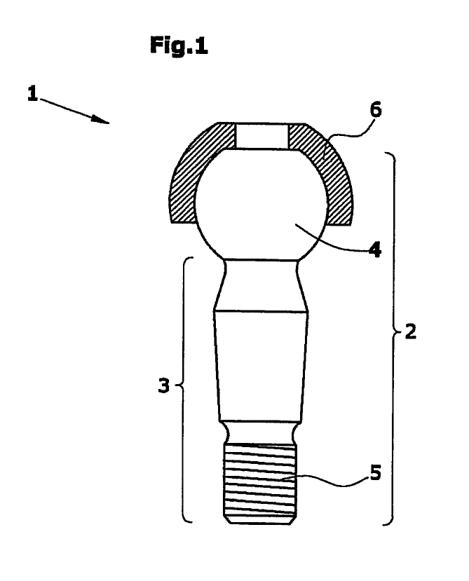

FIG. 1: Schematic illustration of a ball joint 1 with a ball pin 2 comprising a shaft portion 3 with a thread 5 and a ball head 4 and a ball cup 6;

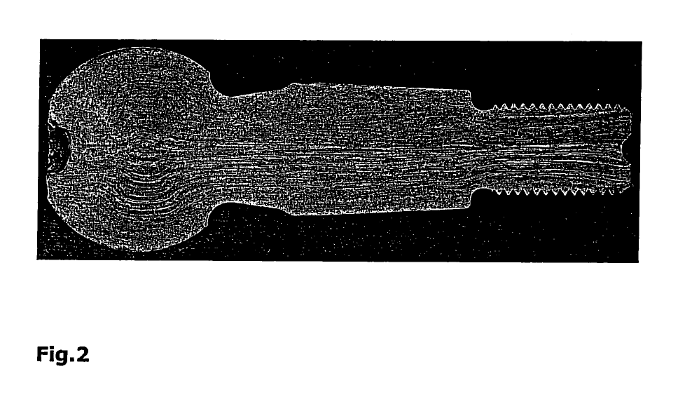

FIG. 2: Cross-section through a ball pin made in accordance with the invention;

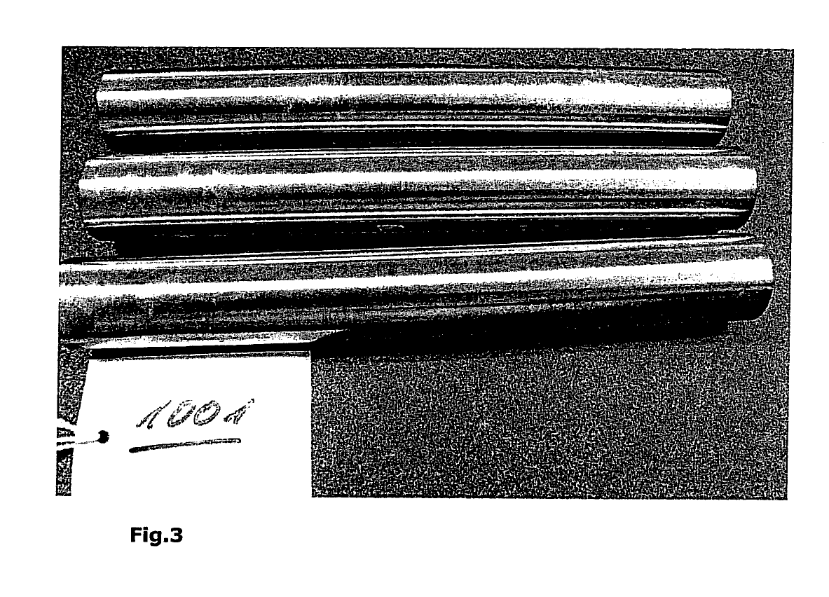

FIG. 3: Turned rods of the material used according to the invention after salt-spray testing;

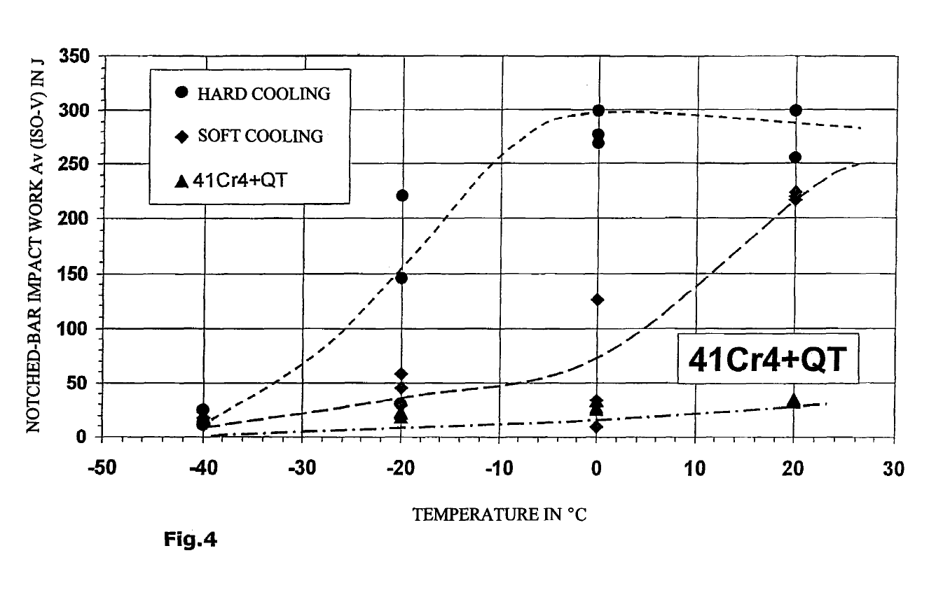

FIG. 4: Notched-bar impact work for ISO-V test pieces;

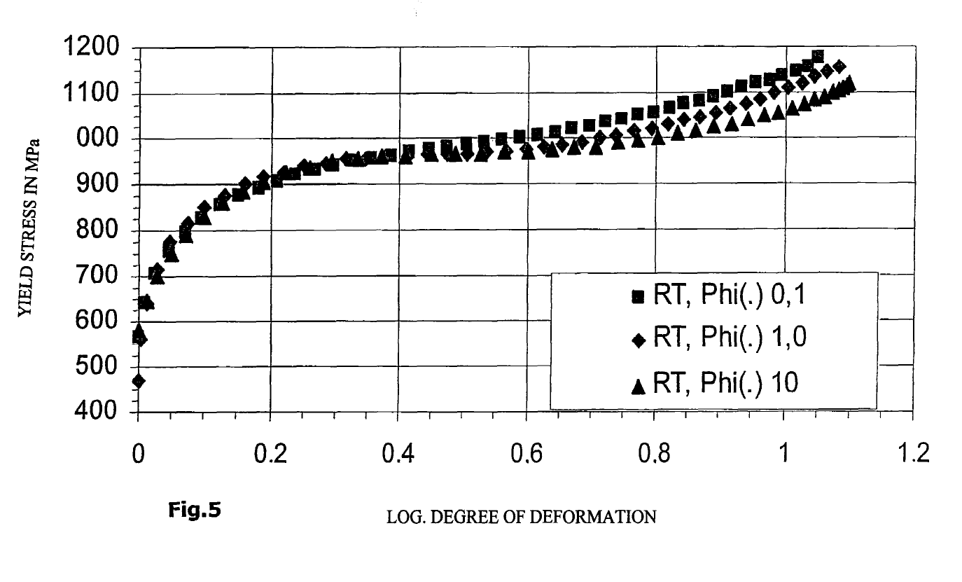

FIG. 5: Yield point of cylindrical test pieces made from the wire bar;

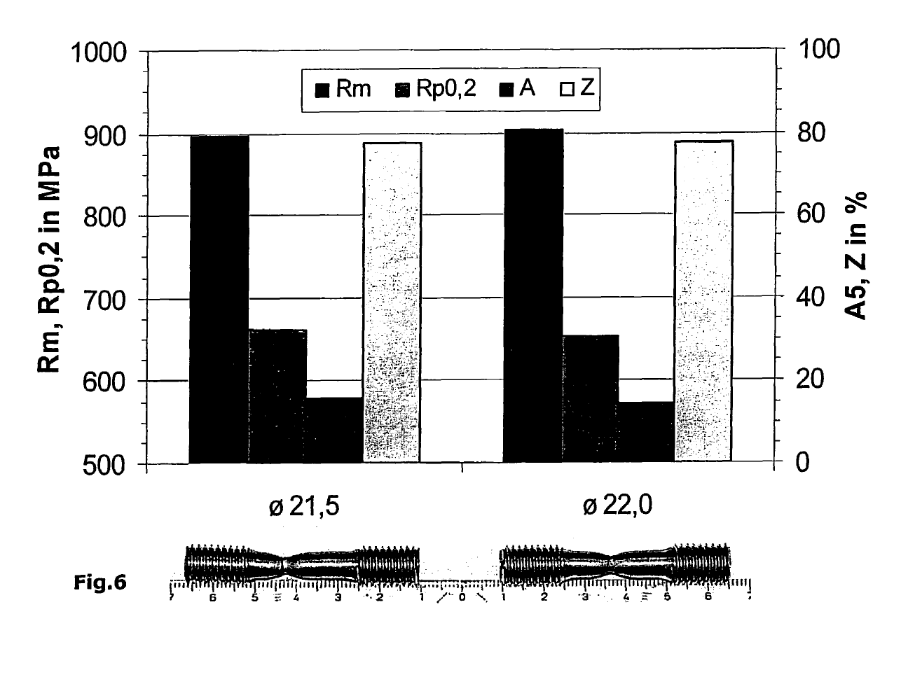

FIG. 6: Mechanical characteristics determined by tensile testing;

FIG. 6A: Chart showing mechanical characteristics tensile strength; and

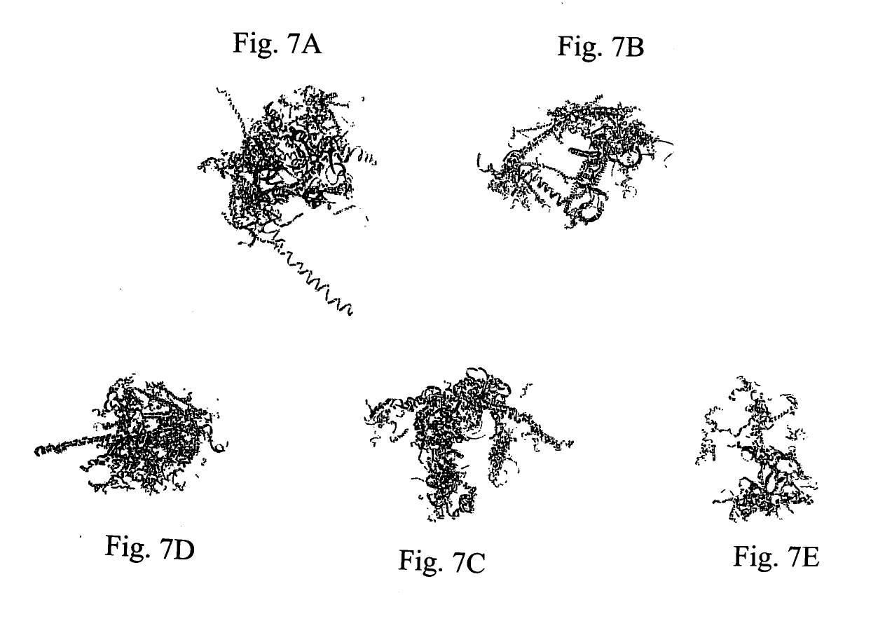

FIG. 7A-E: Shavings produced by turning with various operating parameters

### DETAILED DESCRIPTION OF THE PREFERRED EMBODIMENTS

The invention will be explained in more detail by the following examples:

### EXAMPLE 1

An alloy was made, having the following composition:
12.20 wt.-% of chromium,
0.01 wt.-% of carbon,
0.001 wt.-% of sulfur,
0.77 wt.-% of silicon,
0.38 wt.-% of manganese,
0.02 wt.-% of phosphorus,
0.59 wt.-% of nickel,
0.01 wt.-% of molybdenum,
0.01 wt.-% of aluminum,
0.1 wt.-% of copper,
0.02 wt.-% of nitrogen

### EXAMPLE 2

An alloy was made, having the following composition:
iron, with
12.16 wt.-% of chromium,
0.008 wt.-% of carbon,
0.002 wt.-% of sulfur,
0.73 wt.-% of silicon,
0.43 wt.-% of manganese,
0.005 wt.-% of phosphorus,
0.49 wt.-% of nickel,
0.01 wt.-% of molybdenum,
0.002 wt.-% of aluminum,
0.1 wt.-% of copper,
0.03 wt.-% of nitrogen

### EXAMPLE 3

FIG. 2 shows a cross-section through a ball pin according to the invention. The flow-lines have been made visible by macro-etching. The blank for the ball pin was pressed directly from a drawn rod in a multi-stage cold-forming process. After pressing, the blank was machined and then the thread was rolled. After pressing, the component was not tempered or heat treated. Cold deformation produced tensile strengths in the component of 866 MPa to 1046 MPa. Otherwise than in tempered components, the tensile strength distribution is inhomogeneous as a result of the production method. The tensile strengths were evaluated by conversion from hardness values. The tensile strength of the nitrided standard material reaches values of about 820 MPa.

### EXAMPLE 4

The alloys as specified in examples 1 and 2 were subjected to salt-spray testing in accordance with DIN 50021. After 720 hours only slight rusting had occurred on the underside.

FIG. 3 shows turned rods made from the steel according to example 2 after 720 hours in the neutral salt-spray test according to DIN 50021. Only slight red rusting on the underside of the rods had occurred owing to the formation of a thin layer of rust. The internal test number is 1001. It was found that even a rolled thread resisted corrosion for more than 480 hours in the neutral salt-spray test.

### EXAMPLE 5

The notched-bar impact work was then investigated. FIG. 4 shows the notched-bar impact work for ISO-V test pieces taken from the wire rod, as a function of the test temperature, for two different wire rod cooling conditions. In both cases the temperature at the end of the rolling process was about 1000° C. ‘Hard cooling’ stands for a cooling rate more rapid than 1.5 K/s; ‘soft cooling’ stands for a cooling rate slower than 0.3 K/s. In addition, the notched-bar impact work of the standard material 41Cr4+QT in the tempered condition is plotted as a reference. Throughout the temperature range investigated, the notched-bar impact work of the steel used according to the invention is substantially higher than that of the standard material, and at room temperature reaches values in excess of 250 J. A high notched-bar impact work value is equivalent to high toughness of the material and is essential for safety-critical components in the area of the chassis.

### EXAMPLE 6

Then, the yield point was investigated. FIG. 5 shows that the yield point of cylindrical test pieces taken from the wire rod as a function of the logarithmic degree of deformation (phi), with the deformation rate (phi(.)) as parameter. The logarithmic degree of deformation is calculated from the percentage compression (epsilon) of the specimen, in accordance with:

phi=natural logarithm (1−epsilon)

The deformation rate is the first time derivative of the logarithmic degree of deformation. Already after small degrees of deformation yield points above 800 MPa are obtained. Thus, cold drawing by around 10% is normally sufficient for producing the required strength. The long plateau in the deformation curve shows that no extreme hardening takes place in the component during the multi-stage pressing of the ball pin blank. It is advantageous that the plateau is longer with high deformation rates. The steel is deformed at high deformation rates when the multi-stage pressing is carried out at high power (piece rate per unit time).

### EXAMPLE 7

Then, a tensile test was carried out. FIGS. 6 and 6A show the mechanical characteristics tensile strength Rm, yield point Rp0.2, elongation at fracture A5 and reduction in area at fracture Z determined in the tensile test. The tensile test pieces were taken from two different pressed ball pins. In both cases tensile strengths of 900 MPa were obtained. The ball pins of the prior art had tensile strengths of around 820 MPa.

### EXAMPLE 8

FIGS. 7A-7E show the shavings produced by turning with various machining parameters. Despite the low sulfur content of the steel according to the invention, namely 0.002 wt.-%, no marked tendency to produce tangled shavings was found during the machining of a ball pin or a ball socket.

1-16. (canceled)

17. A ball pin or ball socket made of a stainless steel, wherein the stainless steel comprises a composition of:
10.5 to 13 wt % of chromium;
0.005 to 0.3 wt % of carbon;
a maximum of 0.015 wt % of sulfur;
0.2 to 1 wt % of silicon;
0.2 to 1 wt % of manganese; and
a balance of the composition being essentially iron.

18. The ball pin or ball socket according to claim 17, wherein the carbon content is in a range of 0.005 to 0.02 wt %.

19. The ball pin or ball socket according to claim 18, wherein the chromium content is in a range of 11.5 wt %+10×(carbon content in wt %) to 12 wt %+20×(carbon content in wt %).

20. The ball pin or ball socket according to claim 17, wherein a maximum content of aluminum is 0.06 wt %.

21. The ball pin or ball socket according to claim 17, wherein a maximum content of nickel is 1 wt %.

22. The ball pin or ball socket according to claim 17, wherein the stainless steel further comprises at least one of:
a maximum 0.05 wt % of phosphorus;
a maximum 0.5 wt % of copper;
a maximum 0.5 wt % of cobalt;
a maximum 0.2 wt % of titanium;
a maximum 0.5 wt % of molybdenum;
a maximum 0.01 wt % of niobium;
a maximum 0.01 wt % of boron;
a maximum 0.2 wt % of vanadium; and
a maximum 0.1 wt % of nitrogen.

23. The ball pin or ball socket according to claim 17, wherein the ball pin or the ball socket has a ferritic-martensitic metallurgical structure.

24. The ball pin or ball socket according to claim 17, wherein the ball pin or ball socket exhibits no red rusting after 720 hours in a neutral salt-spray test according to DIN 50021.

25. A method of producing at least one of a ball pin and a ball socket made of a stainless steel having composition of 10.5 to 13 wt % of chromium, 0.005 to 0.3 wt % of carbon, a maximum of 0.015 wt % of sulfur, 0.2 to 1 wt % of silicon, 0.2 to 1 wt % of manganese; and a balance of the composition comprising essentially iron, the method comprising the steps of:
melting the stainless steel;
casting the stainless steel into one of ingots and continuously;
hot rolling the stainless steel;
cold drawing the stainless steel; and
machining the stainless steel.

26. The method according to claim 25, further comprising the step of, after hot rolling, preventing drawing to spheroidal cementite (ASC) from taking place.

27. The method according to claim 25, further comprising the step of pressing a blank of a stainless steel rod in a multi-stage press.

28. The method according to claim 27, further comprising the step of preventing any tempering from occurring after pressing the blank.

29. The method according to claim 25, further comprising the step of, after hot rolling, cold drawing by >5% to produce a required strength.

30. The method according to claim 25, further comprising the step of, after hot rolling, cooling at >1 K/s such that notched-bar impact work in ISO-V test pieces at 0° C.>200 J.

31. The method according to claim 25, further comprising the step of proceeding with the method until the stainless steel has a grain size finer than VII according to either ASTM E 112-96 or DIN EN ISO 643.

32. A stainless steel comprising a composition of: 10.5 to 13 wt % of chromium, 0.005 to 0.3 wt % of carbon, a maximum of 0.015 wt % of sulfur, and 0.2 to 1 wt % of silicon, 0.2 to 1 wt % of manganese and a balance of the stainless steel being essentially iron, and the stainless steel being formed into at least one of a ball pin and a ball socket.
